(19) United States
(12) Patent Application Publication
(10) Pub. No.: US 2023/0106811 A1
(43) Pub. Date: Apr. 6, 2023

(54) Generation of High Yields of Carbon Nanotubes (CNTs) Using Recycled Metal Catalysts

(71) Applicant: Northeastern University, Boston, MA (US)

(72) Inventors: Yiannis A. Levendis, Boston, MA (US); Aidin Panahi, Braintree, MA (US); Chuanwei Zhuo, Lexington, MA (US)

(21) Appl. No.: 17/904,431

(22) PCT Filed: Feb. 19, 2021
(86) PCT No.: PCT/US2021/018775

§ 371 Date: Aug. 17, 2022

Related U.S. Application Data
(60) Provisional application No. 62/978,606, filed on Feb. 19, 2020.

(51) Int. Cl. C01B 32/162

(52) U.S. Cl. CPC C01B 32/162; C01P 2004/03; C01P 2004/13

(57) ABSTRACT

Carbon nanostructure are synthesized by pyrolyzing an organic material. The carbon nanostructures are synthesized on a stainless steel substrate that is reused. After synthesizing the carbon nanostructures, the stainless steel substrate is contacted with an acid, heated, quenched and reused for synthesis of carbon nanostructures.

### RELATED APPLICATION

This application claims the benefit of U.S. Provisional Application No. 62/978,606, filed on Feb. 19, 2020. The entire teachings of the above application are incorporated herein by reference.

### BACKGROUND

Carbon nanostructures can be generated by pyrolysis of organic materials, as described in WO 2010/111624 A1, U.S. Pat. Nos. 9,051,185 B2, and 9,738,524 B2. However, the gaseous decomposition products from pyrolysis of organic materials do not completely convert into carbon nanostructures, thereby contributing to waste.

### SUMMARY

The methods described herein involve pyrolytic or mildly oxidative decomposition of carbon/hydrogen-containing organic materials, including polymers (virgin or post-consumer) or biomass, used as feedstock to generate carbon-bearing gases. These gases are used as donors for growth of carbon nanotubes on catalyst substrates, at temperatures in the range of 600-1200° C.

Pretreated metals, such as stainless steel materials (fixed or floating), can be used to act as catalysts for CNT growth. The pre-treatment of the catalysts involves acid wash for a period of time (e.g., 10 min), followed by oxidation in air at high temperatures (e.g., 800° C.) for a period of time (e.g., 1 min), followed by rapid quenching to room temperature.

Upon removal of the grown carbon nanotubes by sonication in alcohol, the catalysts are treated again, this time by oxidation in air at high temperatures (e.g., 800° C.) for a period of time (e.g., 10-20 min) followed by rapid quenching to room temperature and then by acid wash for a period of time (e.g., 40 min). Upon removal of the grown nanotubes again, the recycling process can be repeated multiple times.

The yield of CNTs increased drastically upon every recycling (with re-treatment of the catalyst) until reaching a plateau. Eventually, after recycling the catalysts several times, the catalysts became fragile and could not be recycled again.

Described herein is a method of synthesizing a carbon nanostructure. The method includes contacting a stainless steel substrate with an acid; heating the stainless steel substrate to at least 600° C.; quenching the stainless steel substrate; in a non-oxidizing environment in a first furnace having a temperature from 600° C. to 1200° C., pyrolyzing an organic material in to obtain one or more gaseous decomposition products; optionally filtering the gaseous decomposition products to remove any solid particles from the gaseous decomposition products; passing the one or more gaseous decomposition products across the stainless steel substrate in a second furnace having a temperature from 600° C. to 1200° C. to form the carbon nanostructure; and removing the carbon nanostructure from the stainless steel substrate. The method is repeated at least once.

The stainless steel substrate can be a wire mesh. The gaseous decomposition products can be passed across a plurality of wire meshes. The stainless steel substrate can include stainless steel chips.

The acid can be hydrochloric acid (HCl) or sulfuric acid (H₂SO₄).

Heating the stainless steel substrate can be performed in air.

The non-oxidizing environment can include an inert gas, such as nitrogen. The non-oxidizing environment can include water vapor.

The method can further include mixing the one or more gaseous decomposition products with an oxidizing gas prior to passing the one or more gaseous decomposition products across the stainless steel substrate in the second furnace. The oxidizing gas can include oxygen. The oxidizing gas can be air.

The organic material can include one or more of polyethylene, polystyrene, polypropylene, and polyamide.

The method can be performed a total of two through seven times.

Heating the stainless steel substrate can be to a temperature from 600° C. to 1200° C.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIGS. 1A-B show the experimental laboratory equipment for pyrolysis of waste plastics and synthesis of carbon nanotubes (CNTs). FIG. 1A depicts generation of CNTs in a purely pyrolytic environment (e.g., in N₂) or a mildly oxidative environment, where oxygen is introduced in a mixing venturi (1: pyrolysis stage, Zone 2: fuel-rich combustion stage*, and Zone 3: CVD-synthesis stage. A ceramic (SiC) honeycomb filter is shown, as well as a section of a stainless steel wire cloth, used as a catalyst substrate for CNT growth. A flame is present at the combustion stage only when oxygen-containing gases are added to the venturi. FIG. 1B is a schematic of an experimental setup.

FIG. 2 is a chart showing yield of CNT grown on SS-316 catalyst using commercial LDPE as a feedstock. y-axis: mass of CNT/mass of catalyst; x-axis: number of uses of the catalyst.

FIGS. 3A-C are SEM images of MW-CNTs grown from LDPE feedstock, at 0.1 lpm, on SS316 catalysts of 400 mesh size. FIGS. 3A and 3B show CNT coverage of the wires from the initial use of the catalyst. FIG. 3C shows CNT coverage of the wires from the second use of the catalyst.

FIGS. 4A-D are SEM images of catalyst wire surfaces that were heat-treated in different step of B series reuse treatment.

FIG. 5 is a graph showing yields (Yc and Yp) of CNT grown on SS-316 catalyst chips (lathe shavings) using commercial LDPE as a feedstock.

FIG. 6 is an SEM image of MW-CNTs grown from LDPE feedstock, at 0.1 lpm, on SS316 catalysts in the form of chips from lathe shavings.

FIGS. 7A-B are graphs showing results of experiments to optimize conditions for treatment of wire cloth catalysts between reusing cycles T=800 C, mp/mc=2.

FIG. 8A-C are graphs showing yields of CNTs: Yc, Yp and Yfinal after both the initial use of 400 mesh wire cloth stainless steel catalyst substrates and a number of reuses of the same substrate, upon receiving treatment.

FIGS. 9A-B are SEM images of CNTs generated on mesh 400 substrate. Top to bottom: Row 1: initial use; Row 2: Reuse 1; Row 3: Reuse 2; Row 4: Reuse 3; Row 5: Reuse 4; Row 6: Reuse 5; Row 7: Reuse 6. Magnification: FIG. 9A, left column: 500; FIG. 9A, right column: 2.5K; FIG. 9B, left column: 15K; FIG. 9B, right column: 30K.

FIG. 10A-B are TEM images of CNTs separated from mesh 400 substrate. Top to bottom: Row 1: initial use; Row 2: Reuse 1; Row 3: Reuse 2; Row 4: Reuse 3; Row 5: Reuse 4; Row 6: Reuse 5; Row 7: Reuse 6. Magnification: FIG. 10A, left column: 27.2K; FIG. 10A, right column: 54.4K; FIG. 10B, left column: 109K; FIG. 10B, right column: 163K.

FIGS. 11A-C are charts showing yields of CNTs: Yc, Yp and Yfinal after both the initial use of 200 mesh wire cloth stainless steel catalyst substrates and a number of reuses of the same substrate, upon receiving treatment.

FIGS. 12A-B are SEM image of CNTs generated on mesh 400 substrate. Top to bottom: Row 1: initial use; Row 2: Reuse 1; Row 3: Reuse 2; Row 4: Reuse 3; Row 5: Reuse 4; Row 6: Reuse 5; Row 7: Reuse 6. Magnification: FIG. 12A, left column: 500; FIG. 12A, right column: 2.5K; FIG. 12B, left column: 15K; FIG. 12B, right column: 30K.

FIGS. 13A-D are SEM images of 400 mesh wire surfaces of the substrates. FIGS. 13A and 13C: initial. FIGS. 13B and 13D: reuse-5. FIGS. 13A and 13B: magnification of 3.5 k. FIGS. 13C and 13D: magnification of 50K.

FIGS. 14A-B are SEM images of the wire surfaces of the 200 mesh substrate after reuse-5. Two different magnifications are shown. Intense surface pitting and roughness is evident.

FIG. 15 is a Raman spectra of the CNTs generated from the initial use of the catalyst substrate and the CNTs collected from the sixth reuse.

FIG. 16 is a graph showing thermo-gravimetric analysis of nanomaterials generated on 400 mesh stainless steel substrates upon sonication in ethanol: from initial use of the catalyst, after reuse 6, and after reuse 6+plus purification in acid to remove iron.

FIG. 17A is an SEM image of a re-used catalyst substrate where wires show evidence of pealing and chipping (see a chip in the upper left corner). FIG. 17B is an SEM image of CNT growth on wire cloth substrate after the sixth reuse. Some impurities can be seen, which may be particles of the catalyst.

### ABBREVIATIONS

CNT: Carbon nanotube

LDPE: Low-density polyethylene

LPM and lpm: Liters per minute

PE: Polyethylene

SEM: Scanning Electron Microscopy

SS: Stainless steel

TEM: Transmission Electron Microscopy

TGA: Thermogravimetric analysis

### DETAILED DESCRIPTION

A description of example embodiments follows.

The methods described herein relate to upcycling of waste plastics to value-added products, namely, carbon nanostructures or nanomaterials, such as carbon nanotubes (CNTs). In general, the methods involve metallic (e.g., stainless steel) substrates (fixed or floating) that are used as catalysts for the growth of nanotubes.

The feedstock can include polymers or other organic materials, such as biomass. The feedstock is either pyrolyzed in an inert gas atmosphere or partially oxidized in a fuel-rich (oxygen-starved) atmosphere. The CNTs are generated using the hydrocarbon-rich pyrolysis or oxidation products as carbon donors. Elevated temperatures in the range of 600-1200° C. are preferred for this process.

Stainless steel substrates are immersed in an acid bath and then exposed to oxidative and thermal treatments to break up their protective chrome layer and activate their surfaces for nanocarbon generation. Thereupon, the ensuing pyrolyzate gases are passed by the substrates to catalytically grow CNTs on their surfaces. CNTs are then removed from the substrates by sonication in alcohol. After removal of the grown CNTs from the catalyst substrates, the substrates are collected, washed with acid, heated, quenched, and then reused for generation of CNTs. The catalyst substrates can be re-used numerous times for generation of CNTs.

Surprisingly, it was discovered that the CNT yields increased by reusing the stainless steel substrates, to achieve multiples of the original yield. Without wishing to be bound by theory, it is believed that iron particles are removed from the catalyst surface during growth of CNTs. In addition, it is believed that the process of acid washing the catalyst, heating the catalyst in air, and quenching the catalyst increases the roughness of the catalyst surface, thereby making it more fertile for CNT growth.

The catalysts can be reused several times with great success in generating high yields of CNTs. After several re-uses, the catalysts become fragile and can no longer be reused. Recycling the same catalyst several times not only improves the CNT yields, but also greatly reduces the operating costs of the process associated with the purchase of catalysts and reduces the volumes of the waste streams.

Experiments were conducted to examine catalyst substrate re-use. Catalyst can be expensive, particularly the stainless steel wire cloths, hence its potential reuse can lower the costs of the process. Experiments conducted with commercial PE demonstrate that reusing a catalyst substrate dramatically enhances the CNT yield.

### Apparatus and Method

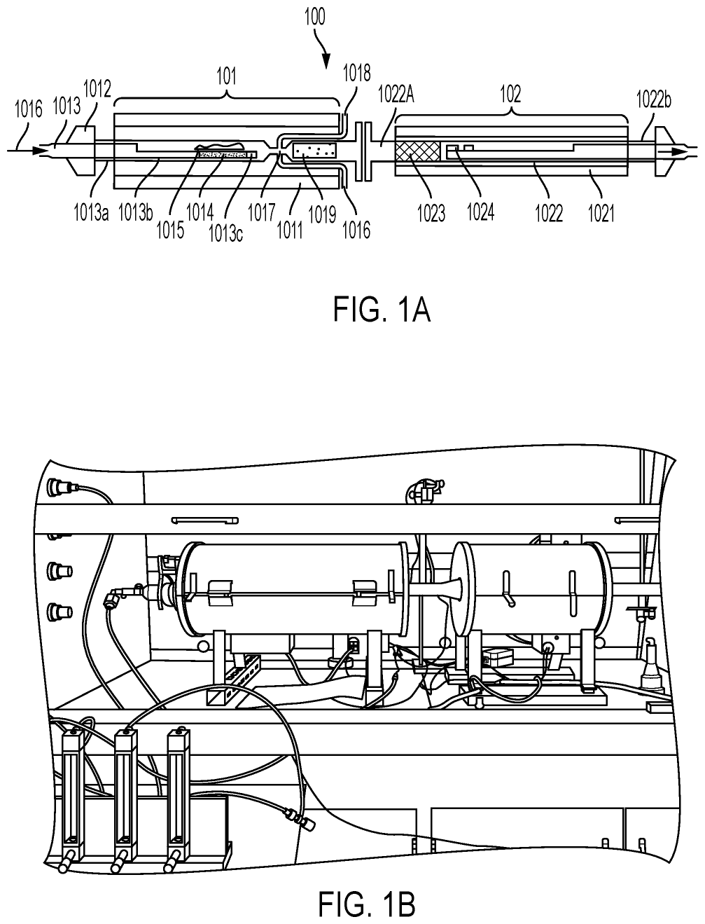

FIGS. 1A-B shows an apparatus 100 containing a primary furnace 101 and a secondary furnace 102 that is useful in generating carbon nanostructures. In certain embodiments, the primary furnace 101 can be a laminar flow muffle furnace and the secondary furnace 102 can be a laminar flow reactor.

As shown in FIG. 1A, the primary furnace 101 contains a primary furnace heating element 1011 to heat the primary furnace chamber 1012. Within the primary furnace chamber 1012, feedstock loading components 1013 can be provided, such as a quartz tube 1013a, which is cut to form a half tube 1013b, onto which a porcelain boat 1013c containing the organic material 1014 can be loaded. The organic material 1014 may be placed at desired or optimal positions within the primary furnace chamber 1012 to carry out pyrolysis therein to form pyrolyzates or gaseous decomposition products 1015.

In certain embodiments, the primary furnace chamber 1012 can contain an inlet 1016 to allow gases, such as an inert gas (e.g., nitrogen, argon, and the like), to enter the primary furnace chamber 1012 so that the pyrolyzation can occur under the desired conditions, such as under inert atmosphere.

The primary furnace 101 can further contain a venturi section 1017 near one end of the primary furnace chamber 1012 so that the gaseous decomposition products 1015 can enter the venturi section 1017. As would be understood by one of ordinary skilled in the art, a venturi section 1017 refers to a constricted section of the primary furnace chamber 1012 that cases a reduction in fluid pressure, which in turn causes an increase in the fluid velocity. Moreover, the venturi section 1017 need not be part of the primary furnace 101 but may be provided as a separate component that is connected to the primary furnace 101.

The venturi section 1017 can further be provided with one or more inlets 1018 that can introduce additional materials, such as one or more gases (e.g., oxidizing agents such as oxygen gas, chlorine gas, carbon dioxide, any other gas containing oxygen, and the like) to mix with the gaseous decomposition products 1015 that enter the venturi section 1017. In certain embodiments, the inlets 1018 can be positioned so that mixing occurs between the gaseous decomposition products 1015 and the one or more gases that enter through inlets 1018. In certain embodiments, the mixing can cause ignition (e.g., auto-ignition) leading to a sooting flame in the post-venturi section 1019. In other embodiments, the mixing can cause ignition and leading to a laminar flame in the post-venturi section 1019.

The post-venturi section 1019 can be connected to a secondary furnace 102, particularly to a first end 1022a of a secondary furnace chamber 1022. The secondary furnace 102 can contain a secondary heating element 1021 to heat the second furnace chamber 1022 to desired temperatures.

An optional filter 1023, such as a ceramic filter, can be included near the first end 1022a of the secondary furnace chamber 1022. However, the filter 1023 need not be part of the secondary furnace 102 but can be provided at any desired location between the primary furnace 101 and the secondary furnace 102. In embodiments where the flame in the post-venturi section 1019 contains particulates (e.g., soot or other particulates), the filter 1023 may act to filter out at least some, most, or all of the particulates from entering the second furnace chamber 1022. One or more filters can be utilized. For example, multiple filters can be stacked together, either placed parallel or in series to further increase the filter efficiency.

The second heating element 1021 may provide sufficient heating to allow the generation of carbon nanostructures in the second furnace chamber 1022. The second furnace 102 may further be equipped with other suitable components, such as a vacuum pump (not shown) and suitable connectors thereof (not shown) to provide sub-atmospheric conditions in the secondary furnace chamber 1022, that can further facilitate, promote, or enhance the formation of carbon nanostructures.

In certain embodiments, the secondary furnace chamber 1022 may contain catalyst 1024 that can aid in the formation of carbon nanostructures. In certain embodiments, the gaseous decomposition products from the post-venturi section 1019 can enter the secondary furnace chamber 1022 to contact the catalyst 1024 contained inside the secondary furnace chamber 1022. As the gaseous decomposition products contact the catalyst 1024, generation of carbon nanostructures can begin, be promoted, or be enhanced. In certain embodiments, the catalyst 1024 can be a supported catalyst that acts as both a catalyst and a carbon nanostructure collecting vessel or a substrate 1025 (not shown). In other embodiments, catalyst 1024 may be a separate component from the substrate 1025.

In certain embodiments, one or more catalysts 1024 can be utilized. For example, multiple stainless steel wire meshes or the like can be stacked together, placed parallel or in series (e.g., folded, rolled, and the like) to further increase the catalyst surface area. In some embodiments, the surface area of the catalyst can increase by 1,000 to several million times depending on the available secondary furnace chamber 1022 and design of apparatus 100.

The carbon nanostructures generated can then be collected from the substrate 1025 as would be readily apparent to one of ordinary skill in the art.

Variations and modifications to the apparatus 100 will be readily apparent to one of ordinary skill in the art and are within the scope of the present disclosure. For example, in certain embodiments, apparatus 100 can be a single furnace containing a primary section and a secondary section, and need not be embodied as two separate furnaces as exemplified in FIG. 1. Other variations and modifications are possible.

Organic materials can be pyrolyzed to form pyrolyzates or gaseous decomposition products. Pyrolysis can occur in the presence of one or more inert gases, such as nitrogen, argon, and the like, preventing ignition and combustion of the pyrolyzates or gaseous decomposition products therein.

In certain embodiments, pyrolysis can be carried out under conditions that allow greater than 80%, 85%, 90%, or even 95% conversion of the organic material to gaseous decomposition products. In certain embodiments, pyrolysis can be carried out at temperatures above 600° C., or above 700° C., or above 800° C., or above 900° C., or even above 1000° C. to maximize the amount of gaseous decomposition products. The temperature in each of the first and second furnaces can be independently adjusted. Typically, the temperature in each of the first and second furnaces is from 600° C. to 1200° C. In some embodiments, the temperature in the first furnace is from 600° C. to 1000° C. In some embodiments, the temperature in the second furnace is from 600° C. to 1000° C. In some embodiments, the temperature in the first furnace is from 800° C. to 1000° C. In some embodiments, the temperature in the second furnace is from 800° C. to 1000° C.

Gaseous decomposition products can be mixed with one or more gases, for example, a gas containing oxygen, to form a flame. The flame may be a sooting flame or a non-sooting flame.

In certain embodiments, to form a flame, the gaseous decomposition products can be released quasi-uniformly using a purposely-designed device (e.g., a continuous feeding system, a fluidizied bed, etc.), and passed into an area, such as the venturi section 1017 shown in FIG. 1A, to effectuate mixing with the one or more gases. Suitable gases to mix with the gaseous decomposition products include gas containing oxygen, such as air. Upon or during mixing, auto-ignition can occur to form a premixed flame.

In some embodiments, the one or more gases may be added at a quantity so that the fuel/oxygen ratio can be made fuel-rich (i.e., oxygen-deficient). Without wishing to be bound by theory, such oxygen-deficient condition may promote growth of carbon nanostructure growth by maintaining a sufficient amount of CO, hydrogen or other suitable feedstock such as small hydrocarbons in the flame.

In certain embodiments, the one or more gases may not contain oxygen or can contain additional gases in addition to oxygen. For example, inert gases, such as, but not limited to, nitrogen, argon, and the like, can be added mixed with the gaseous decomposition products. In certain embodiments, the presence of these other gases may prevent formation of a flame. Rather than forming a flame, the gaseous decompositions products may pass into an area capable of generating carbon nanostructure, such as the secondary furnace chamber 1022 shown in FIG. 1, after being channeled through the particulate filter to form carbon nanostructures.

In embodiments where flame is established, the premixed flame can partially penetrate into the ensuing secondary furnace 1022. In some embodiments, the premixed flame effluents can pass through a filter 1023 to filter out one or more particulates contained in the flame.

The effluents of the flame may then pass through a filter, such as a filter 1023, or any other filter capable of operating under high temperature conditions. The filter can trap at least some solid particles (e.g., soot) before the effluents of the flame is introduced into an area capable of generating carbon nanostructures, such as the secondary furnace chamber 1022 shown in FIG. 1. In certain embodiments, the filter can further act as a flow straightener before the effluents of the flame enter into the secondary furnace chamber 1022.

In some embodiments, selection of appropriate organic materials, absence of oxygenate gases, and non-sooting combustion conditions, can allow for the omission of the filter.

Upon entry into the area capable of generating carbon nanostructures, carbon nanostructures can form. In certain embodiments, the area capable of generating carbon nanostructures, such as the secondary furnace 102, can be maintained at conditions that promote the generation of carbon nanostructures, such as the synthesis temperature ranging from 600° C. to 1500° C., effluent flow velocities ranging from 0.1 cm/s to 10 cm/s, associating with the apparatus 100, and the like.

In certain embodiments, the area capable of generating carbon nanostructures may include one or more catalysts that promote the generation of carbon nanostructures. In some embodiments, the catalyst is a fixed or supported catalyst, which is pre-inserted into the area capable of generating carbon nanostructures. In certain embodiments, the carbon nanostructures can be grown on top of the supported catalysts for subsequent collection.

Alternatively, the gaseous decomposition products can be used as a starting feedstock material for generation of carbon nanostructures in other nanostructure manufacturing processes, such as, but not limited to, chemical vapor deposition (CVD), flow reactor, fluidized beds using floating or supported catalysts, and the like. In such embodiments, any condensed particulates that form in pyrolysis can be removed through filtration of the condensed particulate before the gaseous decomposition products are provided in the nanostructure manufacturing processes. The filtered condensed particulates can be collected so that they are not emitted as environmental pollutants.

In some embodiments, oxygen, hydrogen, sulfur-containing compounds such as thiophene, or combination thereof, such as water vapors, can be added to the primary furnace chamber 1012, the venturi section 1017, or the secondary furnace chamber 1022 to promote activation and maintaining high catalytic activity of the catalysts. The range of the gas to be added may be from about 0.0001% (or 1 ppm) to about 80% by volume.

High-temperature pyrolysis of polymers generates mostly gases (hydrocarbons and hydrogen), with a small fraction of liquids (oils and tars). The oils can be condensed and removed for further use. The gases can be converted to value-added carbon nanotubes with exceedingly high efficiencies when recycled stainless steel catalysts are introduced to the process.

The remaining unreacted pyrolyzate hydrocarbon gases may be burned to generate heat for the process or marketed as a feedstock for other purposes (power generation or chemical feedstock). In addition, heat released during combustion can be recycled as heat to be used for pyrolyzation.

### Metallic Substrates

The metallic substrates used herein can have a variety of configurations, such as wire cloths, particles, waste chips or shreddings. Typically, the metallic substrate is made, at least partially, of stainless steel.

Stainless steels are alloys of iron, chromium, and, in some cases, nickel, molybdenum, manganese, or other metals. Typically, stainless steel contains at least 10-11% chromium and less than 2% carbon. Some types of stainless steel also include nitrogen, aluminium, silicon, sulfur, titanium, nickel, copper, selenium, and/or niobium.

A variety of stainless steel families are known, such as austenitic stainless steel, ferritic stainless steel, martensitic stainless steel, duplex stainless steel, and precipitation hardening stainless steel. Stainless steel are often classified by a three-digit number, such as 304 stainless steel, 316 stainless steel, etc.

Stainless steel substrates are immersed in an acid bath and then exposed to oxidative and thermal treatments to break up their protective chrome layer and activate their surfaces for nanocarbon generation. The acid bath can include hydrochloric acid (HCl) or sulfuric acid (H₂SO₄). The thermal treatment typically involves heating the substrate to at least 600° C. (e.g., approximately 800° C.). After heating the stainless steel substrate is quenched to reduce its temperature, which can be by air quenching or water quenching.

After generating CNTs, the substrates are again washed in acid and heated to remove any remaining carbon from the substrates and to increase the roughness of the surface.

### Organic Materials

In the present disclosure, rather than using expensive and highly purified premium fuels for combustion or CVD process, methods and apparatus to generate of carbon nanostructures using solid organic materials, such as solid waste materials, including solid plastics in the form of pellets, chips, chunks, and the like, as the starting material is described.

Numerous different types of solid organic materials can be utilized in this invention. In certain embodiments, the solid organic material can include a solid plastic, such as, but not limited to, polyethylene, polypropylene, polystyrene, polyvinyl chloride, polylactic acid, polycarbonate, nylon, acrylonitrile butadiene styrene, polymethyl methacrylate, styrene-butadiene rubber, polyamide, or combinations thereof.

In some embodiments, the solid organic material can be in the form of pellets, chips, chunks, or combinations thereof. In yet some other embodiments, the solid organic material can contain various groups, such as an alcohol, alkane, alkene, alkyne, aromatic, acrylate, cellulose, or combinations thereof. Other solid organic materials can be used, such as, but not limited to, biomass, corn, cotton, rubber, tire, coal, wood, lignin, or combinations thereof.

In some embodiments, liquid organic materials can be utilized. For example, liquid organic materials can include, but not limited to, different fractions of the petroleum refining process (e.g., gasoline, diesel, etc.) can be used.

### Carbon Nanostructres

Carbon nanostructures include, but are not limited to, carbon nanofibers with or without hollow cavity, and spherical multi-layer onion carbons. Fiber walls can include amorphous carbon or graphitic structures of different degrees of perfection. Hollow carbon nanofibers with graphitic wall structures containing parallel walls are called carbon nanotubes. Carbon nanotubes are defined based on the number of parallel walls: single-walled nanotubes, double-walled nanotubes, triple-walled nanotubes, and so forth. Generally, carbon nanotubes having multiple number of walls are called multi-walled nanotubes.

### Applications

Carbon nanostructures generated by the methods described herein can be used in a variety of applications.

Major fields of interest including the following nanotube products and their actuators in the conversion of electrical energy to mechanical energy and vice versa, use in robotics, optical fiber switches, displays, and prosthetic devices. Other applications include energy harvesting, batteries, composites, electrostatic dissipation (ESD), and preparation of tires.

For example, carbon nanostructures can be used as electrode material in batteries, either exclusively or as additive, for instance increasing electrical conductivity.

Due to their thermal conductivity, carbon nanostructures such as carbon nanotubes can be used for heat dissipation in electronic devices.

In another example, nanotubes can be used as sensors as correlations between adsorption of gases such as oxygen and conductance and thermoelectric power have been observed. Additional examples include use of nanotubes as composites in a polymer-nanotube combination where improved strength performance is observed. Further enhancements can be obtained by functionalizing the nanotube walls so that nanotube can be anchored to polymeric structures.

In addition, because their physical dimensions are similar to those of biologically active macromolecules such as proteins and DNA, CNTs are useful in biology-related applications, including, but not limited to, detection, drug delivery, enzyme immobilization, and DNA transfection.

Depending on structural characteristics, CNTs can be metallic or semiconducting. The sizes of transistors and logic devices can be reduced significantly using CNTs. For example, a logic device can be made of a single nanotube with a transition between chiralities along its length. Additionally, highly-ordered carbon nanotube arrays can be used for a variety of electronics application ranging from data storage, display, and sensors to smaller computing devices. Commercial application of carbon nanotubes in the area of flat panel displays (FPD) is also credible.

CNTs are also useful as hydrogen storage materials. For example, single-walled nanotubes are suitable for hydrogen storage systems necessary in hydrogen-powered vehicles.

### EXEMPLIFICATION

A description of example embodiments follows.

### Example #1

Feedstocks were pyrolyzed at high temperature, in an inert atmosphere, in the first stage of the reactor (the feedstock pyrolysis furnace), and the resulting pyrolyzates gases were channeled into the second stage of the apparatus (the CNT synthesis furnace) (FIGS. 1A-B). Therein, they first passed through a high-temperature ceramic SiC filter (manufactured by Ibiden Corp. of Japan) to remove any generated solid particles (soot, etc.). Such filtration prevents catalyst deactivation by deposition thereupon of any possibly generated soot. This filter has a retention efficiency of 97% for soot particles bigger than 1 μm, and was periodically thermally-regenerated by passing high-temperature air. Upon exiting the filter, the effluent gases were passed through a wire cloth.

The catalysts were pre-treated as follows: they were first acid washed with a dilute hydrogen chloride solution (35%), then they were rinsed with de-ionized water, they were subsequently heat-treated at 800° C. in air for one minute, and then they were rapidly air-quenched to room temperature.

The commencement and the completion of the feedstock pyrolysis, as well as the simultaneous CNT synthesis reactions, were inferred by monitoring the evolution of visible fumes at the exit of the second reactor. Upon termination of each run, the furnaces were turned off and allowed to cool down to room temperature. The catalyst substrate screens were then removed and sections therefrom were cut and prepared for analysis by Scanning Electron Microscopy (SEM). Other screen sections were sonicated in neat ethyl alcohol for 1 hour to remove the CNTs for additional analysis by Transmission Electron Microscopy (TEM) and Raman spectroscopy.

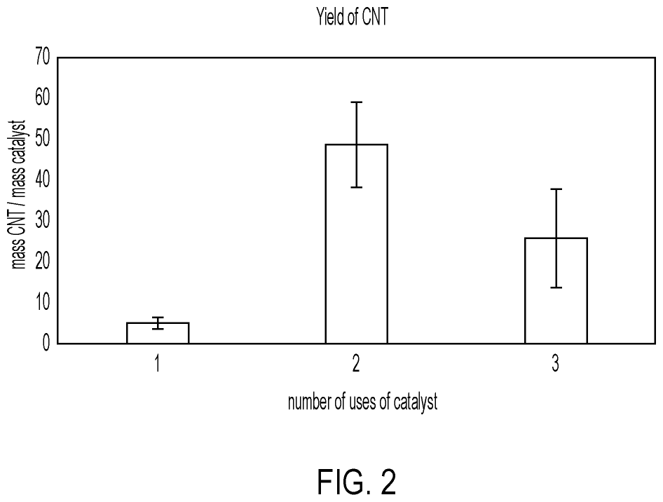

Two series of experiments were conducted, and in each series the same catalyst substrates was used 3 times. The process took place at 800° C. in both furnaces in the presence of nitrogen carrier gas at a flowrate of 0.1 lpm. After using the catalysts the first time, the grown CNTs were removed by sonication. Thereafter, the catalysts were placed again in an oven in air for 10 min to remove any leftover CNTs. Then they were acid washed for 10 min. The experimental conditions and the results are shown in Table 1 and plotted in FIG. 2. It can be seen that the CNT yields, both based on the mass of catalyst and on the mass of polymer, increased greatly when the catalysts were reused. Yields as high as 56% were reached.

SS-316 400 mesh wire cloths were used as catalysts. Their fine wires became fragile after repeated cycles of oxidation, acid treatment and CNT growth. As a result, they often disintegrated as they were handled to carry on the next experiments. Consequentially, the weight of catalyst was not consistent after each reuse. Two series of experiments, (A and B), are shown in Table 1.

TABLE 1
Experimental data from reusing stainless steel wire cloth catalyst substrates

| | Mass of | Mass of | Mass | | Flow | | | Yield | Yield |
|---|---|---|---|---|---|---|---|---|---|
| | catalyst | polymer | CNTs | Polymer/ | rate | T1 | T2 | based on | based on |
| | (g) | (g) | (g) | Catalyst | (lpm) | (° C.) | (° C.) | catalyst | polymer |
| A1 | 15.74 | 7.92 | 0.74 | 0.5 | 0.1 | 800 | 800 | 4.8 | 9.3 |
| A2 | 3.41 | 4.32 | 2.41 | 1.3 | | | | 55.8 | 55.6 |
| A3 | 1.47 | 1.47 | 0.51 | 1.0 | | | | 34.0 | 34.5 |
| B1 | 15.45 | 1.62 | 0.59 | 0.1 | | | | 3.8 | 36.3 |
| B2 | 5.66 | 5.66 | 2.33 | 1.0 | | | | 41.0 | 41.1 |
| B3 | 0.28 | 0.28 | 0.05 | 1.0 | | | | 17.1 | 17.1 |

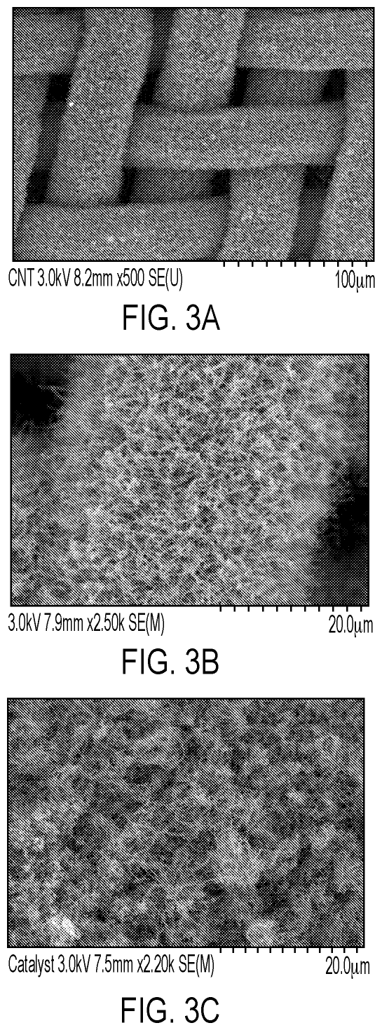

SEM images of CNTs grown on these SS316 catalyst surfaces from low-density polyethylene (LDPE) feedstock in nitrogen carrier gas are shown in FIG. 3. The catalyst wires appear more densely populated when generated on SS316 from 2nd reuse experiment.

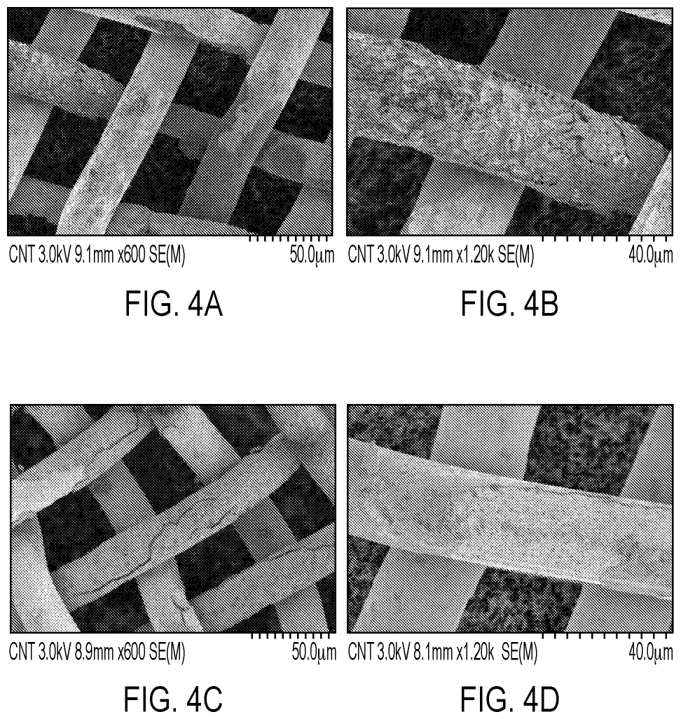

SEM images of the SS316 400 mesh wire-cloth surfaces after the second re-use are shown in FIGS. 4A-D. After each use these SS 316 400 mesh wire cloths are subjected to high temperatures at 800° C. for 10 min to burn out any residual carbon, they are then subjected to acid wash for 10 min and to oxidation at 800 C for 1 min as well. As a result, they become very eroded and pitted. Eventually, after 3 uses they fell apart.

Since the wire-cloth catalysts were disintegrated after a few re-uses, attention was turned to stainless steel chips (metal shavings). These chips can be produced turning stainless steel rods. Waste chips may also be found in the market at reasonable process. One avenue is to purchase scrap metal and turn it into chips. One source in the interne advertises scrap SS316 metal for 0.45 $/lb.

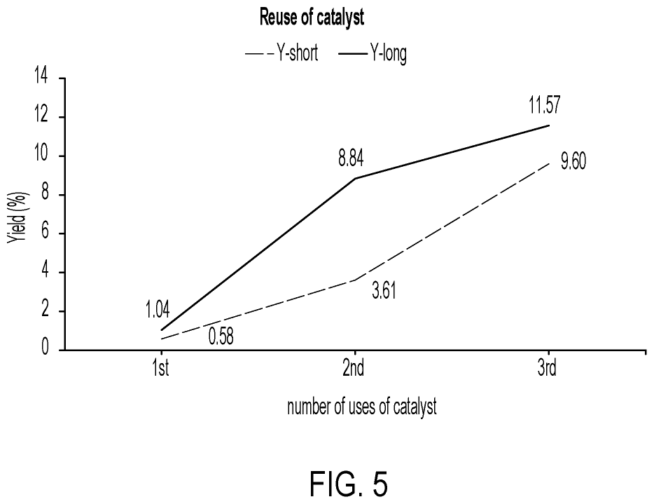

Two series of experiments were conducted with machine chips and extruded post consumer PE. The chips were used and reused four times. Like the wire cloths, they also showed remarkable improvement in yields over time. The long chips of the metal rod shavings on the lathe were bunched up and they made a long catalyst substrate (9.5 g) and a shorter catalyst substrate (5 g). The catalyst-to-polymer mass ratio was kept at unity, hence the polymer mass was approximately the same as that of the catalyst. After each use, the catalyst was washed in acid (HCl) for 1 hour and heated in air (800° C.) for 8 min. Results are shown in FIG. 5.

Since the mass of the catalyst and the mass of the polymer were approximately the same in these experiments, the CNT yield based on the polymer mass (YP) and the CNT yield based on the catalyst mass (YC) were also the same. Initial yields were low, since the chips (shavings) were much thicker in diameter than the wires in the wire cloths, hence the total surface area of the catalyst was much less than in the case of the wire cloths. But remarkably the yields increased with reuse experiments by a factor of 10. As these chips were thicker than the wires they were less prone to disintegration, and a fourth reuse was achieved.

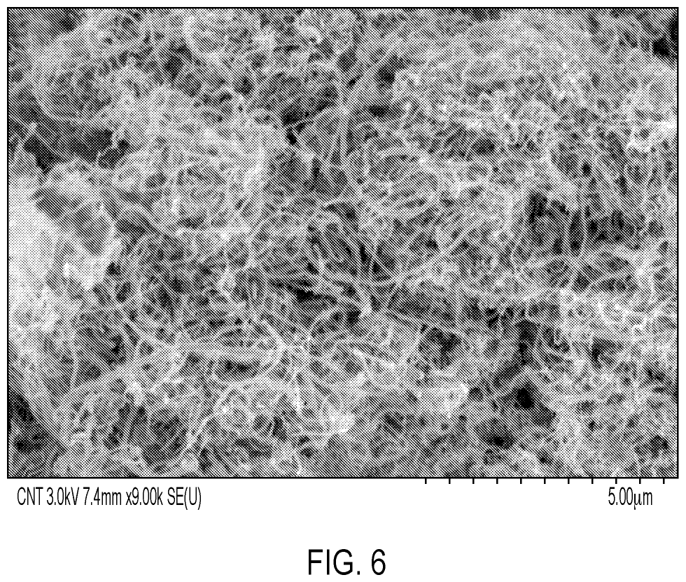

An SEM image of the collected nanotubes on the surfaces of SS 316 chips is shown in FIG. 6. The process of using and re-using SS 316 chips was not optimized in these preliminary experiments, but it showed promise for lowering the operating cost of a commercial application.

### Example #2

Example 2 demonstrates the extent to which CNT yield increases when the wire cloth catalytic substrates are reused, upon removal of the grown CNTs by sonication in alcohol. For this study the 400 mesh was selected for most testing, but a 200 mesh was also tested in order to compare the effectiveness and the durability of the substrates. The inert gas flow rate was 0.1 lpm. Upon removal of the CNTs from the catalyst, by sonication in alcohol, the same catalyst substrate was re-used several times and the CNT yields were measured gravimetrically and plotted. Yields were also assessed based on the amount of CNT collected upon removal from the substrates with sonication. A supply of 316 stainless steel cloths was procured from Cleveland Wire Cloth & Manufacturing Company (Cleveland, Ohio, USA), as they seemed to be more durable than those used in Example 1.

Example 2 also assessed the characteristics and quality of the generated nanotubes (MWCNTs) by scanning electron microscopy (SEM), transmission electron microscopy (TEM), Raman spectroscopy, and thermogravimetric analysis (TGA).

### Summary

Carbon nanotubes were generated from post-consumer polyethylene plastics. A process involving high-temperature feedstock pyrolysis to gas, and subsequent synthesis of CNTs by chemical vapor deposition (CVD) on stainless steel wire-cloth catalysts, at a similarly high temperature, was used. This experiment demonstrated that the yield of nanomaterials can be increased drastically when the wire cloth substrates are reused. However, to be reused such substrates need to be washed in acid, rinsed with water, heat-treated, and then air-quenched to room temperature. Mass yields of CNTs attached on the catalyst as high as 50% were attained, based on the amount of polymer feedstock, when a sufficient amount of catalyst was present. SEM and TEM images were acquired to identify the structure of the CNTs. Raman spectroscopy explored their multiwall nanotube content. SEM images of the wire cloth catalyst surfaces were also acquired in between reuses and revealed their increasing roughness and coarseness, with increasing number of reuses, which is likely to have promoted the increased productivity of the substrate. The final mass yields of CNTs upon their removal from the catalyst were as high as 25-50%, based on the amount of polymer feedstock. However, they were seen to contain iron impurities, since they were magnetic. Finally, an acid treatment was applied to purify the collected CNTs and remove the iron.

### Approach

The feedstocks were pyrolyzed at high temperature, in an inert atmosphere, in the first stage of the reactor (the feedstock pyrolysis furnace), and the resulting pyrolyzate gases were channeled into the second stage of the apparatus (the CNT synthesis furnace) (FIG. 1). Therein, they first passed through a high-temperature ceramic SiC filter (manufactured by Ibiden Corp. of Japan) to remove any generated solid particles (soot, etc.). Such filtration prevents catalyst deactivation by deposition thereupon of any possibly generated soot. This filter has a retention efficiency of 97% for soot particles bigger than 1 μm, and was periodically thermally-regenerated by passing high-temperature air. Upon exiting the filter, the effluent gases were passed through a cartridge containing a homemade honeycomb, consisting of multiple rolls of wire cloths, or bunched up stainless steel strap and steel wool or steel chips from machining operations.

Parameter settings:

Feedstock: shredded PE polymer

Pyrolysis furnace temperature: 800° C.

Synthesis furnace temperature: 800° C.

Carrier gas and flow rate: Nitrogen at 0.1 lpm

Mass ratio of polymer to catalyst: 2 in explorative work (Example 2.1), 0.1 in screen reusing work (Example 2.2)

Yields of grown CNTs, on a mass basis, were calculated in three different ways based on the formulas listed below:

Yield of CNTs based on catalyst (Y_{c}):

$${Y}_{c} ( \% ) = \frac{Mass of CNT}{Mass of Catalyst} \times 100 \qquad ( 1 )$$

Yield of CNTs based on polymer (Yₚ):

$${Y}_{p} ( \% ) = \frac{Mass of CNT}{Mass of Polymer} \times 100 \qquad ( 2 )$$

Yield of CNTs after separation based on polymer (Y_{final}):

$${Y}_{final} ( \% ) = \frac{Mass of CNT after separation}{Mass of Polymer} \times 100 \qquad ( 3 )$$

The first yield of CNTs, Y_{c}, is calculated per mass of catalyst with the CNTs still on the substrate. The second yield, Yₚ, is calculated per mass of polymer feedstock with the CNTs still on the substrate. The third yield, Y_{final}, is calculated per mass of polymer feedstock with the CNTs removed from the substrate and collected.

### Example 2.1. Exploratory Experiments to Identify Effective Treatment of Wire Cloth Catalysts Between Catalytic Substrate Reusing Cycles

First of all the CNTs were removed by sonication in alcohol.

Afterwards, air cleaning (AC) of the substrates was implemented in a 800° C. furnace for 10 or 20 min to ensure that any left over CNTs were burned out.

Alcohol Sonication (AS) of the substrates was then implemented for 30 min for further cleaning.

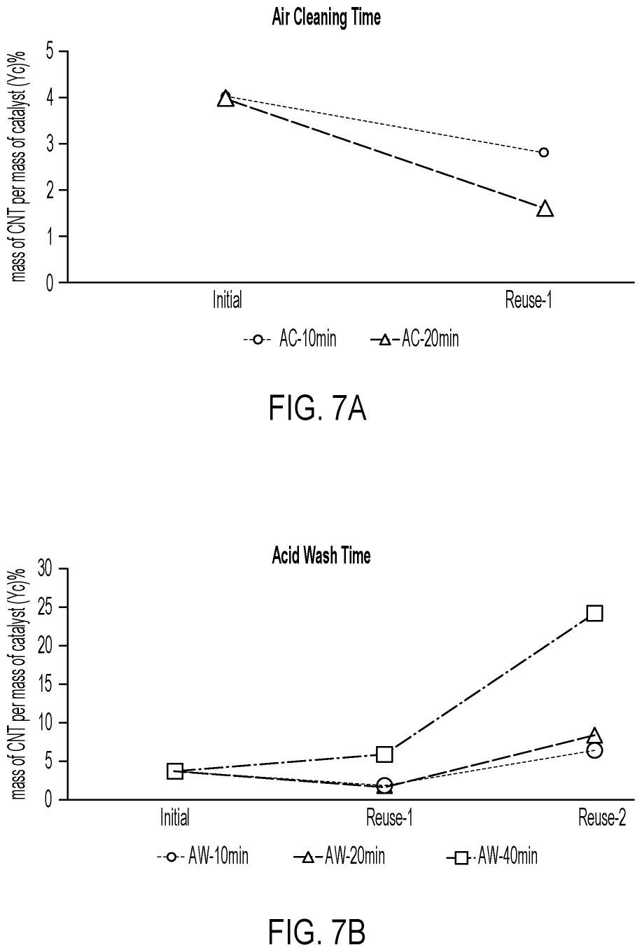

Acid Wash (AW) was finally implemented for 10 to 40 min, to increase the roughness of surface and remove iron oxides. Results are shown in Table 2 and FIG. 7.

TABLE 2
Results of exploratory work

| Original | | | | M(with | | | M(Total | | |
|---|---|---|---|---|---|---|---|---|---|
| # of Roll | M | M(Total) | M(Polymer) | CNT) | M(CNT) | Yc | CNT) | Yc | Yp |
| 1 | 0.5054 | 4.9928 | 10.0598 | 0.5226 | 0.0172 | 3.40 | 0.1980 | 3.97 | 1.97 |
| 2 | 0.5086 | | | 0.5251 | 0.0165 | 3.24 | | | |
| 3 | 0.5052 | | | 0.5249 | 0.0197 | 3.90 | | | |
| 4 | 0.4898 | | | 0.5108 | 0.0210 | 4.29 | | | |
| 5 | 0.4999 | | | 0.5187 | 0.0188 | 3.76 | | | |
| 6 | 0.5060 | | | 0.5276 | 0.0216 | 4.27 | | | |
| 7 | 0.5067 | | | 0.5281 | 0.0214 | 4.22 | | | |
| 8 | 0.5022 | | | 0.5209 | 0.0187 | 3.72 | | | |
| 9 | 0.4873 | | | 0.5066 | 0.0193 | 3.96 | | | |
| 10 | 0.4817 | | | 0.5055 | 0.0238 | 4.94 | | | |
| | | Air cleaning for 10 min at 800° C. | | | Air cleaning for 20 min at 800° C. | | | | |
| | | # of Roll 1 and 2 | | | # of Roll 3 and 4 | | | | |
| Reuse-1 | | | | M(with | | | M(Total | | |
| # of Roll | M | M(Total) | M(Polymer) | CNT) | M(CNT) | Yc | CNT) | Yc | |
| 1 | 0.5081 | 1.0171 | 4.0329 | 0.5205 | 0.0124 | 2.44 | 0.0266 | 2.62 | |
| 2 | 0.5090 | | | 0.5232 | 0.0142 | 2.79 | | | |
| 3 | 0.5069 | 0.9986 | | 0.5177 | 0.0108 | 2.13 | 0.0185 | 1.85 | |
| 4 | 0.4917 | | | 0.4994 | 0.0077 | 1.57 | | | |
| | | Acid (60%) wash | | Acid (60%) wash | | Acid (60%) wash | | | |
| | | for 10 min | | for 20 min | | for 40 min | | | |
| | | # of Roll 5 and 6 | | # of Roll 7 and 10 | | # of Roll 8 and 9 | | | |
| Reuse-1 | | | | M(with | | | M(Total | | |
| # of Roll | M | M(Total) | M(Polymer) | CNT) | M(CNT) | Yc | CNT) | Yc | |
| 5 | 0.5011 | 0.9943 | 6.0093 | 0.5109 | 0.0098 | 1.96 | 0.0319 | 3.21 | |
| 6 | 0.4932 | | | 0.5153 | 0.0221 | 4.48 | | | |
| 7 | 0.5068 | 0.9887 | | 0.5164 | 0.0096 | 1.89 | 0.0170 | 1.72 | |
| 10 | 0.4819 | | | 0.4893 | 0.0074 | 1.54 | | | |
| 8 | 0.4977 | 0.9797 | | 0.5223 | 0.0246 | 4.94 | 0.0532 | 5.43 | |
| 9 | 0.4820 | | | 0.5106 | 0.0286 | 5.93 | | | |
| Reuse-2 | | | | M(with | | | M(Total | | |
| # of Roll | M | M(Total) | M(Polymer) | CNT) | M(CNT) | Yc | CNT) | Yc | |
| 5 | 0.4993 | 1.0043 | 6.0052 | 0.5383 | 0.0390 | 7.81 | 0.0732 | 7.29 | |
| 6 | 0.5050 | | | 0.5392 | 0.0342 | 6.77 | | | |
| 7 | 0.5036 | 0.9829 | | 0.5466 | 0.0430 | 8.54 | 0.0767 | 7.80 | |
| 10 | 0.4793 | | | 0.5130 | 0.0337 | 7.03 | | | |
| 8 | 0.4824 | 0.9482 | | 0.6001 | 0.1177 | 24.40 | 0.2284 | 24.09 | |
| 9 | 0.4658 | | | 0.5765 | 0.1107 | 23.77 | | | |

Based on these exploratory experiments, the most effective treatment on reuse of the wire cloth catalyst substrates was identified as follows: (1) air cleaning at 800° C. for 10 min, (2) sonication in alcohol for 10 min, (3) acid wash for 40 min.

### Example 2.2. Systematic CNT Growth Experiments on Original and Reused Substrates to Identify How Many Times Can Be Re-Used, Both Mesh 400 and Mesh 200

### Example 2.2.1. Yields of CNTs Generated on and Separated from Mesh 400 Substrates

Six (6) reuse experiments were conducted with 400 mesh SS 316 substrates. After each use, the substrates were acid washed with a dilute hydrogen chloride solution (35%), rinsed with de-ionized water, heat-treated at 800° C. in air for one minute, and then rapidly air-quenched to room temperature.

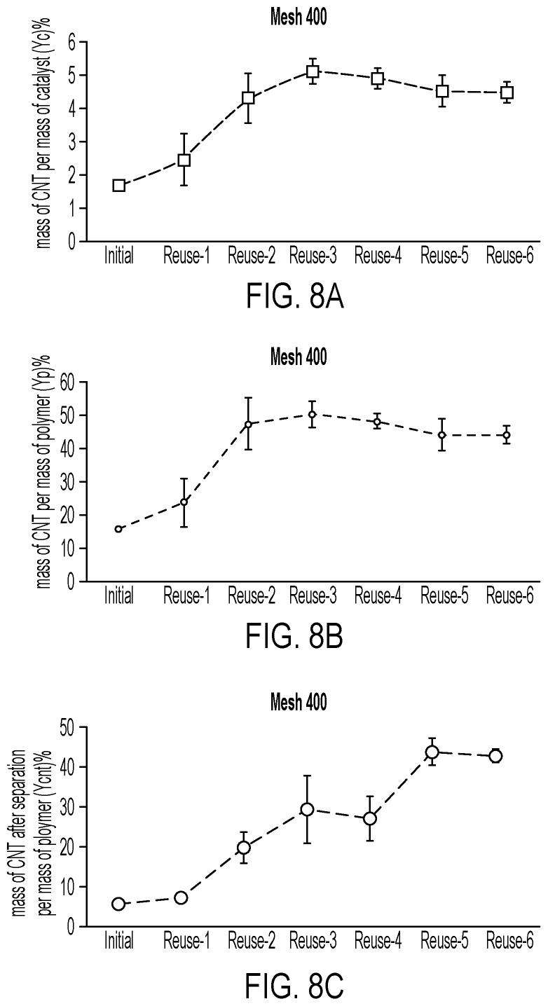

The three different yields Y_{c}, Yₚ and Y_{final} are plotted below in FIGS. 8A-C. Detailed results are included in Table 3. It can be seen that the nanocarbon yields increased remarkably with reuse of the substrates until reaching a plateau. Yields Yₚ as high as 50% per mass of polymer were attained, see the green line in FIG. 8B. Yields Y_{final} as high as 50% per mass of polymer were also obtained after removal of the CNTs from the wire cloth substrates by sonication; however, these numbers are a bit optimistic as losses are present when CNT are removed from the beaker after evaporation of the ethanol. This was further investigated by TGA (Example 2.5).

TABLE 3
Data on CNT generation by reusing mesh 400
Initial

| | M | | | | |
|---|---|---|---|---|---|
| | (catalyst) | M(polymer) | M(CNT) | Yc | Yp |
| Test-1 | 6.2498 | 0.6265 | 0.1002 | 1.60 | 15.99 |
| Test-2 | 6.1154 | 0.6098 | 0.0962 | 1.57 | 15.78 |
| Test-3 | 15.1718 | 1.6070 | 0.2634 | 1.74 | 16.39 |
| Test-4 | 14.8603 | 1.6089 | 0.272 | 1.83 | 16.91 |

| | M(CNT) | Y_{final} |
|---|---|---|
| Test-1 | 0.0351 | 5.60 |
| Test-2 | 0.0377 | 6.18 |
| Test-3 | 0.0959 | 5.97 |

Reuse-1

| | M | | | | |
|---|---|---|---|---|---|
| | (catalyst) | M(polymer) | M(CNT) | Yc | Yp |
| Test-1 | 6.2063 | 0.6311 | 0.1432 | 2.31 | 22.69 |
| Test-2 | 5.9895 | 0.6127 | 0.1954 | 3.26 | 31.89 |
| Test-3 | 5.9931 | 0.6022 | 0.1041 | 1.74 | 17.29 |
| Test-4 | 5.8557 | 0.5884 | 0.0974 | 1.66 | 16.55 |

| | M (CNT) | Y_{final} |
|---|---|---|
| Test-1 | 0.027 | 4.28 |
| Test-2 | 0.0502 | 8.19 |
| Test-3 | 0.0393 | 6.53 |

Reuse-2

| | M | | | | |
|---|---|---|---|---|---|
| | (catalyst) | M(polymer) | M(CNT) | Yc | Yp |
| Test-1 | 5.8383 | 0.5892 | 0.3134 | 5.37 | 53.19 |
| Test-2 | 5.5468 | 0.5516 | 0.2811 | 5.07 | 50.96 |
| Test-3 | 5.8225 | 0.5906 | 0.2294 | 3.94 | 38.84 |
| Test-4 | 5.7638 | 0.5731 | 0.1581 | 2.74 | 27.59 |

| | M (CNT) | Y_{final} |
|---|---|---|
| Test-1 | 0.137 | 23.25 |
| Test-2 | 0.126 | 22.84 |
| Test-3 | 0.102 | 17.27 |

Reuse-3

| | M | | | | |
|---|---|---|---|---|---|
| | (catalyst) | M(polymer) | M(CNT) | Yc | Yp |
| Test-1 | 5.4524 | 0.5515 | 0.2926 | 5.37 | 53.06 |
| Test-2 | 5.2158 | 0.5233 | 0.2396 | 4.59 | 45.79 |
| Test-3 | 5.3862 | 0.5492 | 0.2884 | 5.35 | 52.51 |
| Test-4 | 5.158 | 0.5212 | 0.2564 | 4.97 | 49.19 |

| | M (CNT) | Y_{final} |
|---|---|---|
| Test-1 | 0.1425 | 25.84 |
| Test-2 | 0.1254 | 23.96 |
| Test-3 | 0.216 | 39.33 |

Reuse-4

| | M | | | | |
|---|---|---|---|---|---|
| | (catalyst) | M(polymer) | M(CNT) | Yc | Yp |
| Test-1 | 5.0682 | 0.5070 | 0.2323 | 4.58 | 45.82 |
| Test-2 | 4.7684 | 0.4881 | 0.2456 | 5.15 | 50.32 |
| Test-3 | 4.8643 | 0.4847 | 0.2396 | 4.93 | 49.43 |

| | M (CNT) | Y_{final} |
|---|---|---|
| Test-1 | 0.1498 | 29.55 |
| Test-2 | 0.1024 | 20.98 |
| Test-3 | 0.1525 | 31.46 |

Reuse-5

| | M | | | | |
|---|---|---|---|---|---|
| | (catalyst) | M(polymer) | M(CNT) | Yc | Yp |
| Test-1 | 4.5653 | 0.4784 | 0.1966 | 4.31 | 41.10 |
| Test-2 | 4.3425 | 0.4397 | 0.2195 | 5.05 | 49.92 |
| Test-3 | 4.2936 | 0.424 | 0.1786 | 4.16 | 42.12 |

| | M (CNT) | Y_{final} |
|---|---|---|
| Test-1 | 0.174 | 36.37 |
| Test-2 | 0.2041 | 46.42 |
| Test-3 | 0.1774 | 41.84 |

Reuse-6

| | M | | | | |
|---|---|---|---|---|---|
| | (catalyst) | M(polymer) | M(CNT) | Yc | Yp |
| Test-1 | 3.7316 | 0.3841 | 0.1803 | 4.83 | 46.94 |
| Test-2 | 3.374 | 0.3249 | 0.1453 | 4.31 | 44.72 |
| Test-3 | 3.8083 | 0.392 | 0.1638 | 4.30 | 41.79 |

| | M (CNT) | Y_{final} |
|---|---|---|
| Test-1 | 0.128 | 33.32 |
| Test-2 | 0.1433 | 44.11 |
| Test-3 | 0.1659 | 42.32 |

### Example 2.2.2: SEM Images of CNTs Generated on Mesh 400 Substrates

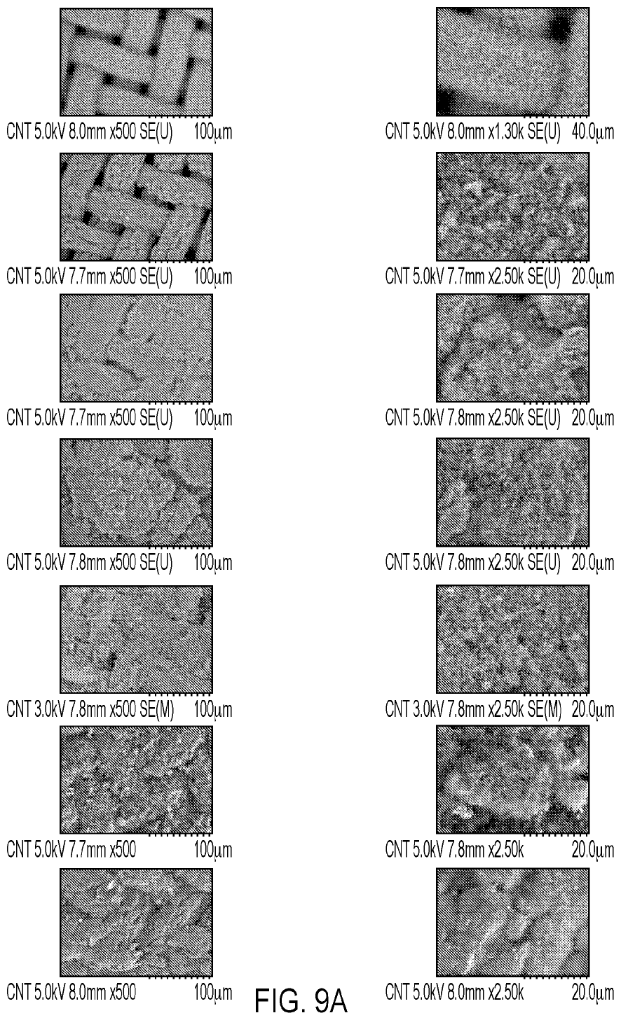

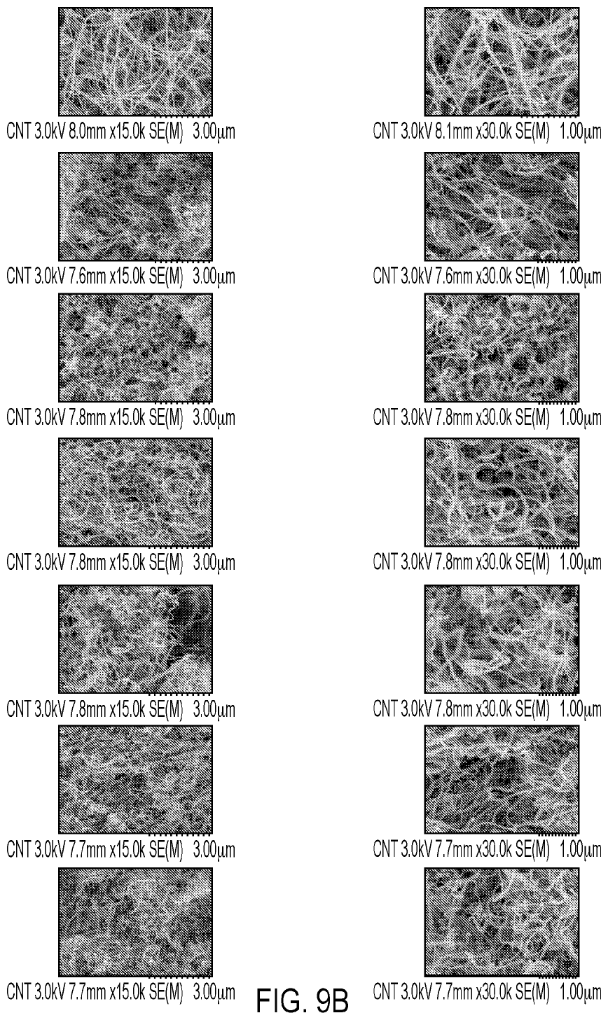

SEM images of CNTs generated on mesh 400 substrates are shown in FIG. 9. The seven rows correspond to the initial use of the substrates and the six reuse experiments. The four columns correspond to four different magnifications: 500, 2.5K, 15K, 30K. In all of these images, the generated nanomaterials appear to be mostly carbon nanotubes. One can see that upon reuse of the catalytic substrates the growth of nanomaterials is massive; the individual wires of the catalyst and the spaces in between are completely covered up by nanomaterials.

### Example 2.2.3: TEM Images of CNTs Separated from Mesh 400 Substrates

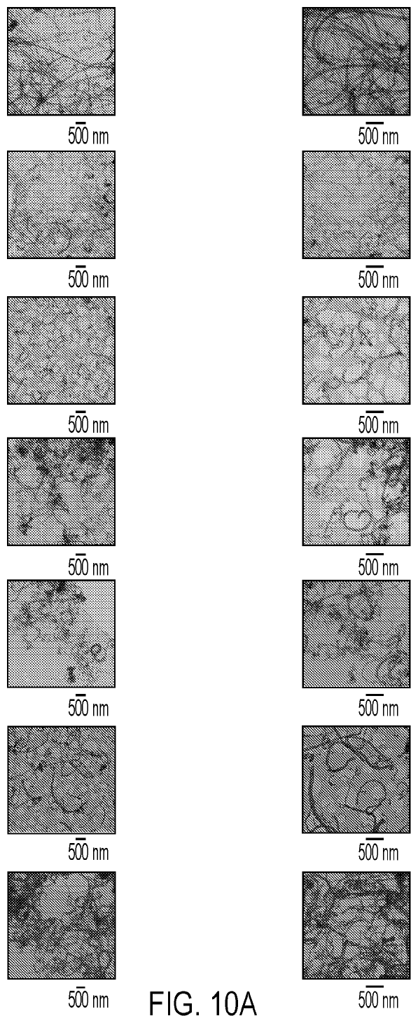

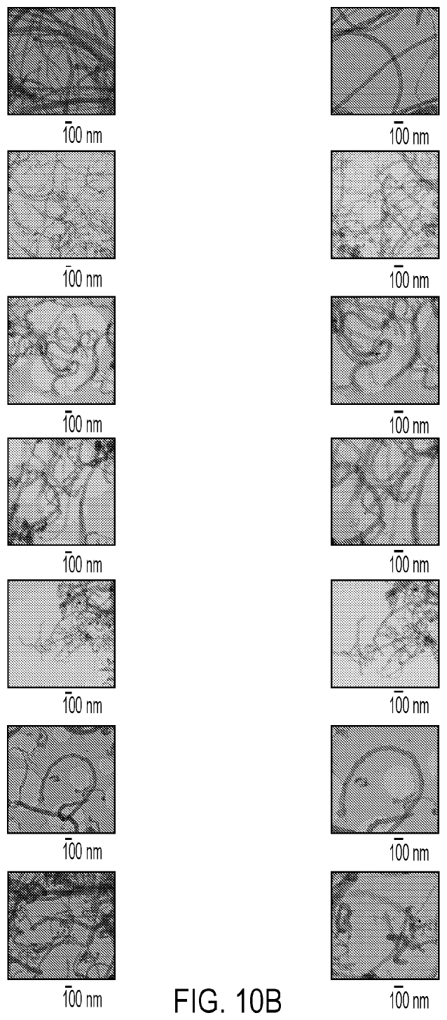

TEM images of CNTs generated on mesh 400 substrates are shown in FIG. 10. The seven rows correspond to the initial use of the substrates and to the six reuse experiments. The four columns correspond to four different magnifications: 27.2K, 54.4K, 109K, 163K. In all of these images, the generated nanomaterials appear to be mostly carbon nanotubes.

### Example 2.2.4: Yields of CNTs Generated on and Separated from Mesh 200 Substrates

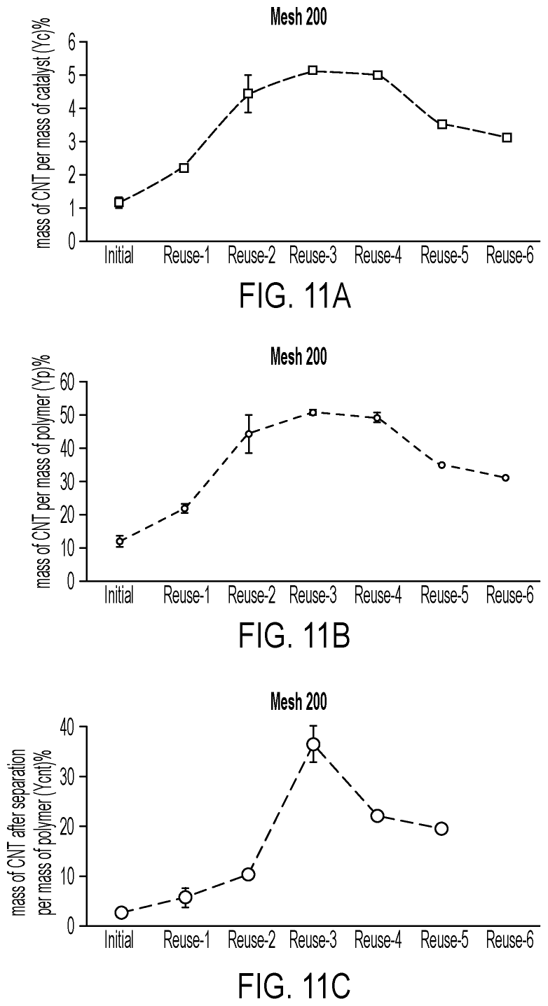

Six (6) reuse experiments were conducted with 200 mesh SS 316 substrates. After each use, the substrates were acid washed with a dilute hydrogen chloride solution (35%), rinsed with de-ionized water, heat-treated at 800° C. in air for one minute, and then rapidly air-quenched to room temperature. The three different yields Y_{c}, Yₚ and Y_{final} are plotted below in FIGS. 11A-C. Detailed results are included in Table 4. It can be seen that, as in the case of the 400 substrates, the nanocarbon yields increased remarkably with the reuse of the substrates. The yields reached a maximum at reuse number 3, and then decreased with the number of reuses. Yields Y_{final} almost as high as 50% per mass of polymer were attained. The last two points. Again, such a high number is questionable, given the collection loses from a beaker. All experiments were repeated two times or even three times if the first two experiments did not agree. Hence, if no error bars appear in any of the points in FIGS. 11A-C, it means that the first two tests were in agreement.

TABLE 4
Data on CNT generation by reusing mesh 400
Initial

| | M | | | | |
|---|---|---|---|---|---|
| | (catalyst) | M(polymer) | M(CNT) | Yc | Yp |
| Test-1 | 9.0896 | 0.9034 | 0.113 | 1.24 | 12.51 |
| Test-2 | 9.1563 | 0.9164 | 0.1161 | 1.27 | 12.67 |
| Test-3 | 8.9585 | 0.9089 | 0.0919 | 1.03 | 10.11 |
| Test-4 | 8.9098 | 0.8906 | 0.1139 | 1.28 | 12.79 |

| | M (CNT) | Y_{final} |
|---|---|---|
| Test-1 | 0.0273 | 3.02 |
| Test-2 | | |
| Test-3 | 0.0233 | 2.56 |
| Test-4 | 0.0224 | 2.52 |

Reuse-1

| | M | | | | |
|---|---|---|---|---|---|
| | (catalyst) | M(polymer) | M(CNT) | Yc | Yp |
| Test-1 | 8.8548 | 0.8847 | 0.2006 | 2.27 | 22.67 |
| Test-2 | 8.2971 | 0.8236 | 0.1301 | 1.57 | 15.80 |
| Test-3 | 8.7802 | 0.8809 | 0.1816 | 2.07 | 20.62 |
| Test-4 | 8.5829 | 0.8777 | 0.193 | 2.25 | 21.99 |

| | M (CNT) | Y_{final} |
|---|---|---|
| Test-1 | 0.0641 | 7.25 |
| Test-2 | | |
| Test-3 | 0.0335 | 3.80 |
| Test-4 | 0.0471 | 5.37 |

Reuse-2

| | M | | | | |
|---|---|---|---|---|---|
| | (catalyst) | M(polymer) | M(CNT) | Yc | Yp |
| Test-1 | 8.3141 | 0.8313 | 0.4163 | 5.01 | 50.08 |
| Test-2 | 7.3462 | 0.738 | 0.2503 | 3.41 | 33.92 |
| Test-3 | 8.1889 | 0.8042 | 0.3568 | 4.36 | 44.37 |
| Test-4 | 7.9392 | 0.7981 | 0.3093 | 3.90 | 38.75 |

| | M (CNT) | Y_{final} |
|---|---|---|
| Test-1 | 0.0143 | 1.72 |
| Test-2 | | |
| Test-3 | 0.0169 | 2.10 |

Reuse-3

| | M | | | | |
|---|---|---|---|---|---|
| | (catalyst) | M(polymer) | M(CNT) | Yc | Yp |
| Test-1 | 7.8888 | 0.786 | 0.4048 | 5.13 | 51.50 |
| Test-2 | 6.3197 | 0.6418 | 0.3072 | 4.86 | 47.87 |
| Test-3 | 7.705 | 0.7817 | 0.4036 | 5.24 | 51.63 |

| | M (CNT) | Y_{final} |
|---|---|---|
| Test-1 | 0.306 | 38.93 |
| Test-2 | | |
| Test-3 | 0.2651 | 33.91 |

Reuse-4

| | M | | | | |
|---|---|---|---|---|---|
| | (catalyst) | M(polymer) | M(CNT) | Yc | Yp |
| Test-1 | 6.5138 | 0.6623 | 0.3198 | 4.91 | 48.29 |
| Test-2 | 5.1104 | 0.5136 | 0.2213 | 4.33 | 43.09 |
| Test-3 | 6.4288 | 0.6433 | 0.3256 | 5.06 | 50.61 |

| | M (CNT) | Y_{final} |
|---|---|---|
| Test-1 | 0.1546 | 23.34 |
| Test-2 | | |
| Test-3 | 0.1351 | 21.00 |

Reuse-5

| | M | | | | |
|---|---|---|---|---|---|
| | (catalyst) | M(polymer) | M(CNT) | Yc | Yp |
| Test-1 | 4.7317 | 0.4754 | 0.1688 | 3.57 | 35.51 |
| Test-2 | | | | | |
| Test-3 | 4.582 | 0.458 | 0.1574 | 3.44 | 34.37 |

| | M (CNT) | Y_{final} |
|---|---|---|
| Test-1 | 0.1409 | 29.64 |
| Test-2 | | |
| Test-3 | 0.0891 | 19.45 |

Reuse-6

| | M | | | | |
|---|---|---|---|---|---|
| | (catalyst) | M(polymer) | M(CNT) | Yc | Yp |
| Test-1 | 3.6622 | 0.3673 | 0.1141 | 3.12 | 31.06 |
| Test-2 | | | | | |
| Test-3 | | | | | |

| | M (CNT) | Y_{final} |
|---|---|---|
| Test-1 | | |
| Test-2 | | |
| Test-3 | | |

### Example 2.2.5: SEM Images of CNTs Generated on Mesh 200 Substrates

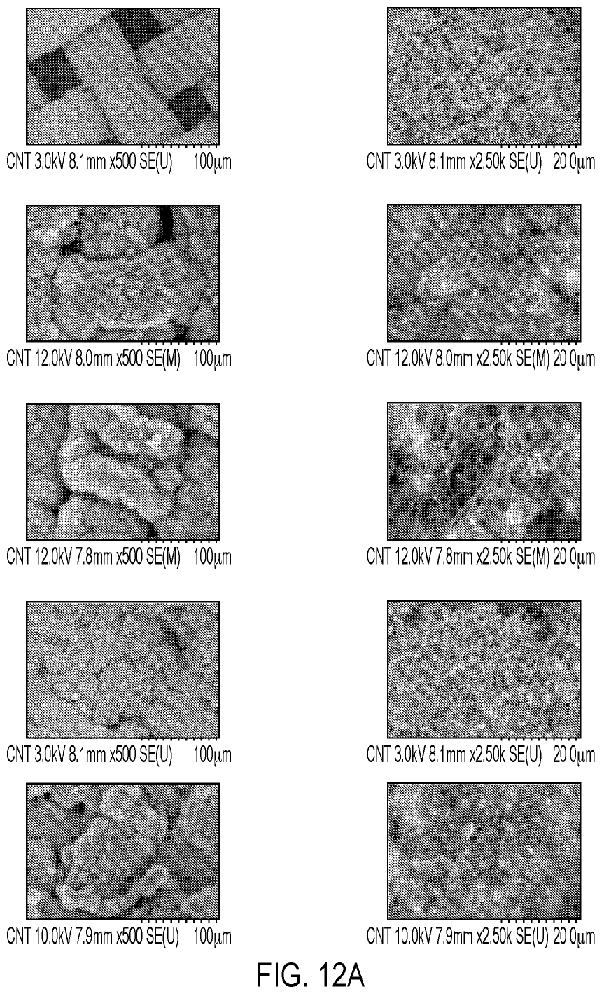

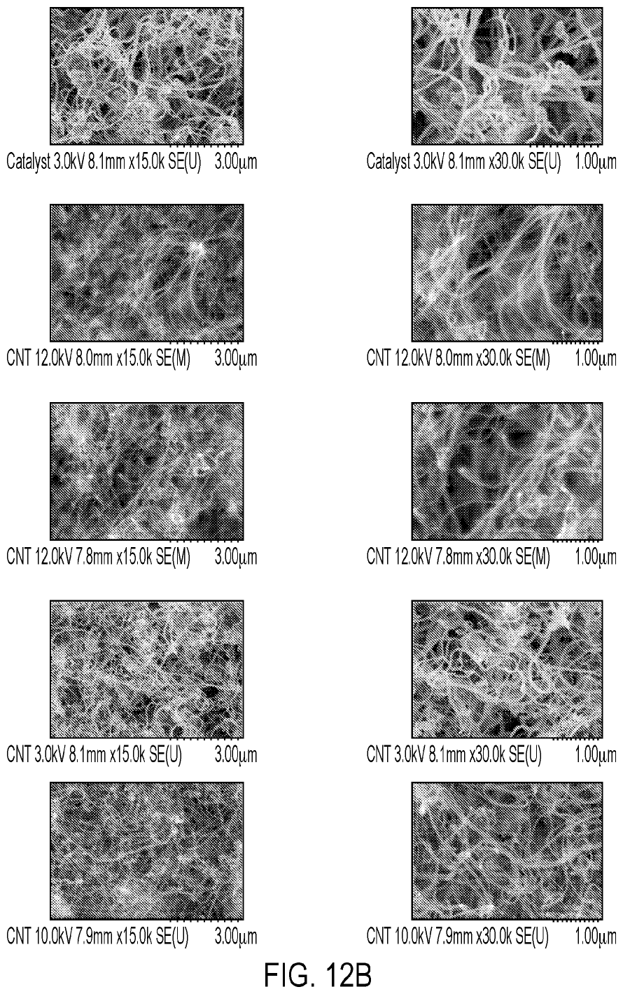

SEM images of CNTs generated on mesh 200 substrates are shown in FIG. 12. The seven rows correspond to the initial use of the substrates and the six reuse experiments. The four columns correspond to four different magnifications: 500, 2.5K, 15K, 30K. In all of these images, the generated nanomaterials appear to be mostly carbon nanotubes. Again, one can see that upon reuse of the catalytic substrates the growth of nanomaterials is massive; the individual wires of the catalyst and the spaces in between are completely covered up by nanomaterials.

### Example 2.2.6: After Reuse-6, the Substrates Deformed and Softened

After reuse-6, the substrates were deformed and were too soft to support additional reuses. Experiments were did not take place after the sixth reuse of the 400 mesh stainless steel substrates. They were not rigid enough to be fitted in the cartridge. The 200 mesh stainless steel substrates were, as expected, more rigid than the 400 mesh substrates, and perhaps they could have been subjected to additional reuses. Pictures of the 200 mesh stainless steel substrates show, as expected, that they are stiffer as their wires are thicker.

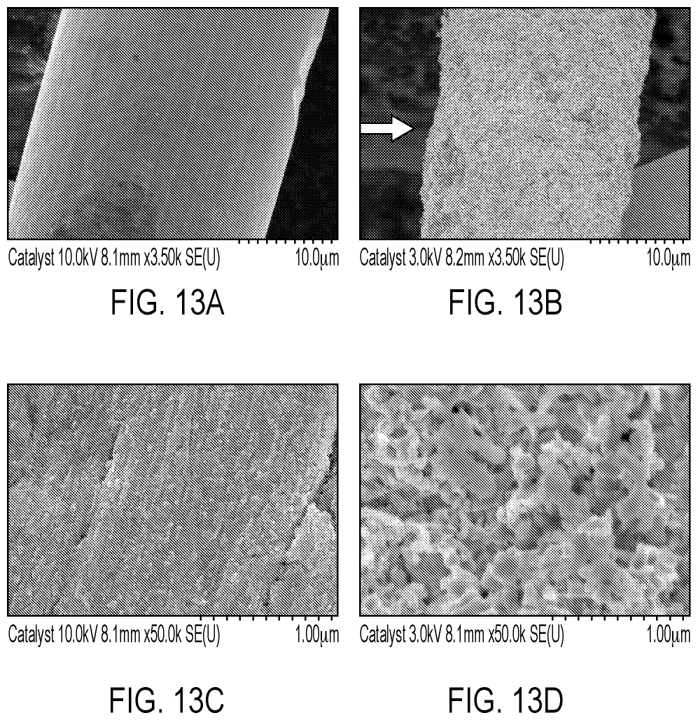

Close examination of the stainless steel wires is very telling (FIGS. 13A-D), where SEM images are displayed. FIGS. 13A and 13C show the surface of a 400 mesh wire after the initial growth of CNTs. At low magnification (FIG. 13A), the surface of the wire appears to be somewhat smooth, but at higher magnification (FIG. 13C), the surface roughness is apparent (this wire has undergone two acid treatments, one before the initial growth of CNTs and one afterwards to condition it for the first reuse). These two acid treatments and the growth of CNTs have pitted the surface.

FIGS. 13B and 13D show the surface of a 400 mesh wire after 5 reuses. At low magnification (FIG. 13B), the surface of the wire appears to be very rough, and the diameter of the wire has been reduced by 18%. This means that the mass of the wire has been reduced by 33%. Such reductions are noteworthy and can be attributed to (a) acid treatments and (b) the tip growth mechanism of CNTs which removes metal from the substrate. At higher magnification (FIG. 13D), the intense surface roughness is apparent (this wire has undergone six acid treatments, one before the initial growth of CNTs and five afterwards to condition it for the first reuse). These six acid treatments and the growth of CNTs have severely pitted the surface.

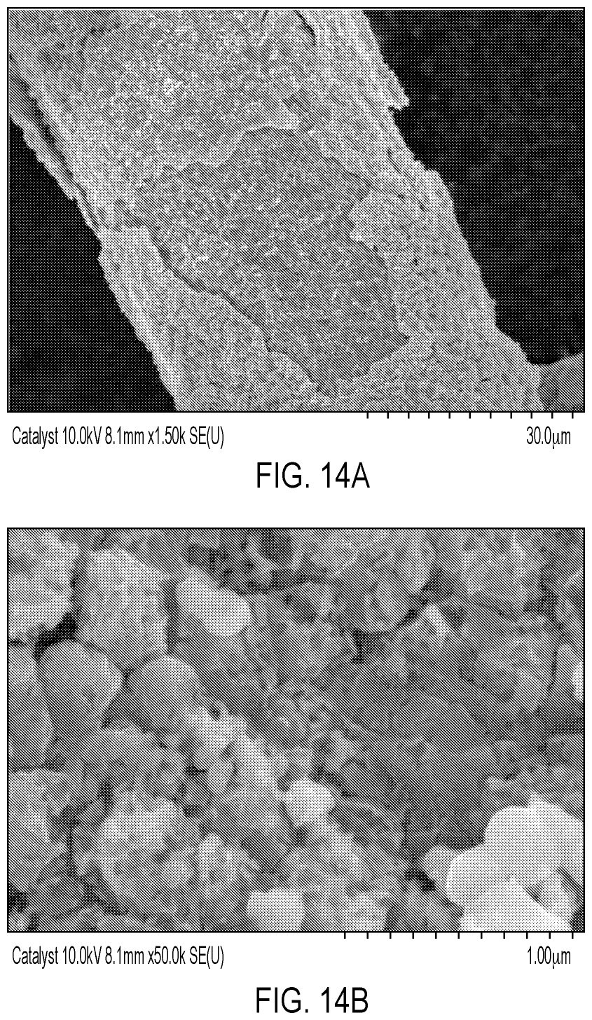

As can be seen from the images displayed in FIGS. 13 and 14A-B, the surface morphology of the reused wire cloth catalyst substrates has been severely altered. This is a result of two synergistic mechanisms: (a) the pitting and cracking of the surface layer by the repeated action of the combined punishing treatment (acid wash, oxidation and rapid quenching), which is very abrasive to the surface, and (b) the “tip growth” mechanism of these nanotubes, where metal particles are detached from the wire-cloth and move at the head of growing nanotubes. This detachment of the metal particles further pits the surface severely. These combined mechanisms drastically increase the roughness and coarseness of the surface and, by doing so, they increase its effective surface are that is available for growth of nanotubes. To provide a mental image, the result is akin to that of plowing or tilling the earth by farmers to plant seeds for growing plants.

### Example 2.3. Characterization of the Collected CNTs by Raman Spectroscopy

Raman spectroscopy was used for characterization of CNTs. The presence of disorder in sp²-hybridized carbons leads to rich phenomena in their resonance Raman spectra, thus making Raman spectroscopy an informative techniques to characterize disorder in sp² carbon materials. The peak around 1350 cm⁻¹, called the D-band, represents the extent of disorder in the sp² arrangement of carbon atoms. The intensity of the D-band reflects the disorder in sp²-hybridized carbon networks and provides a qualitative estimate for the abundance of defects, amorphous carbon nano-crystalline impurities in the sample. The peak around 1590 cm⁻¹ (G-band) corresponds to the in-plane oscillation of carbon atoms in the sp² graphite sheet of SWCNTs. The peak around 2690 cm⁻¹, the 2D (or G′) band, originates from the two-phonon double resonance Raman process and represents the long range order in the sample. Quantifying disorder in a graphene monolayer is usually made by analyzing the ratio of the peaks. Strong presence of G band intensity over D band intensity, I_{G}/I_{D}, indicates a high degree of structural ordering and purity for the nanomaterials. The ratio I_{2D}/I_{G} indicates the presence of parallel graphitic layers. High values for these ratios indicate a strong degree of structural ordering and MWCNT content in the nanomaterials.

### Example 2.3.1. Indication of MWCNT Content in the Nanomaterials Generated from Reuse-6 of Mesh 400 Substrates

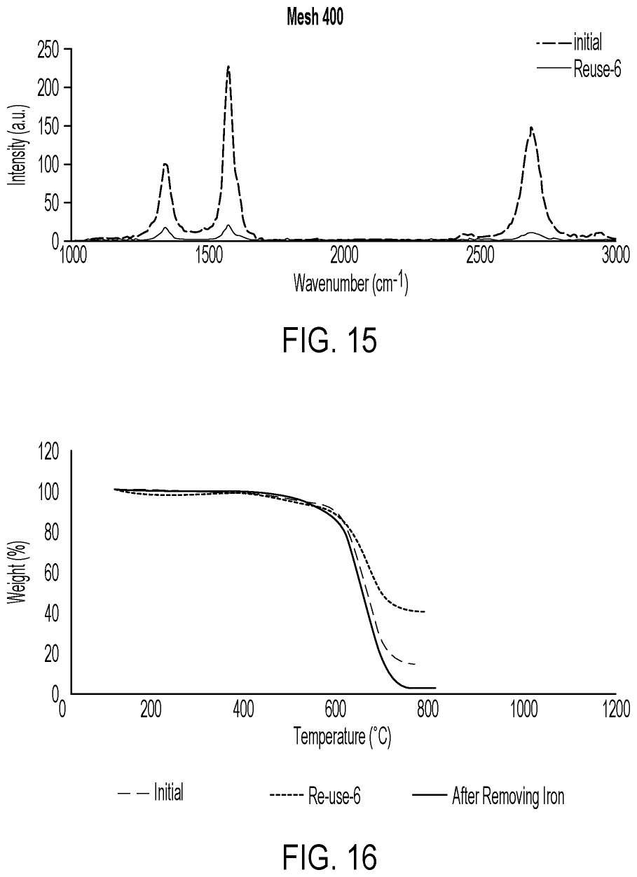

Using the calculated ratios as indicators, it appears that the multiwall CNT (MWCNT) content in these nanomaterials (i.e., the MWCNT purity) is higher during the initial synthesis run. During the final run, such indicators are lower. Theoretically, this means that other carbons such as nanocarbons that are not purely tubular, but instead have some discontinuities or defects, inclusion of heteroatoms, or they are of other shapes and forms, such as nano-ropes are present. The Raman spectra of the CNTs generated from the initial use of the catalyst substrate and the CNTs collected from the sixth reuse of the catalyst are superimposed in FIG. 15. The I_{D}, I_{G} and I_{2G} peaks are well-defined in FIG. 15.

TABLE 5
Raman Peak Ratios and Derived MWNT Purity Values

| | I_{D}/I_{G} ratio | | I_{G′}/I_{G} ratio | | I_{G′}/I_{D} and | | |
|---|---|---|---|---|---|---|---|
| | andMWNT | | and MWNT | | and MWNT | | Average |
| Mesh 400 | Purity | | Purity | | Purity | | Purity |
| Initial | 0.44 | 78 | 0.65 | 70 | 1.46 | 74 | 74 |
| Reuse-6 | 0.81 | 22 | 0.64 | 68 | 0.78 | 44 | 45 |

### Example 2.4. Purification of Collected CNTs

A magnetic field, induced by a hand-held magnet, was applied to a vial containing CNTs suspended in alcohol. It revealed that the generated nanomaterials were magnetic, most likely because they contain iron inclusions. These inclusions were picked up from the stainless steel wire cloth substrates during the “tip growth” mechanism of the nanotubes. As mentioned before, in this mechanism metal particles are detached from the wire-cloth and move at the head of growing nanotubes. Continuous formation of carbon atoms at the support side grows CNTs with the metal particle lifted at the tip of CNTs. To remove such metallic inclusions as well as any loose iron that was chipped away from the substrate, the collected nanotubes were immersed in 35% solution of hydrochloric acid and sonicated for 5 hrs. Upon the termination of this treatment, the magnet could not pull the nanomaterials to its side any more. Thus, the magnetic property of the generated nanomaterials ceased to exist. It was concluded that the iron particles were removed from the CNTs. Afterwards, the materials were filtered out of the solution with a microporous filter, were rinsed with distilled water and were dried for TGA analysis (Example 2.5).

### Example 2.5. Thermo-Gravimetric Analysis of the Collected CNTs

The carbon purity of the generated CNTs was obtained with thermogravimetric analysis (TGA). In these experiments the nanomaterials generated from the PE pyrolyzates during the initial use of the 400 mesh wire cloth substrates were examined. Sample results are shown in FIG. 16, where nanomaterials from (a) the initial use of the catalyst were burned in air, (b) those from reuse 6 (as-removed) were also burned in air, (c) those from reuse 6 (acid purified) were also burned in air. Based on these limited tests, it can be seen that CNTs generated from the initial use of the catalyst had some inorganic content, which we typically see in such CNTs, in the order of 10%. This is mostly attributed to metal inclusions in the tubes based on their “tip growth” which detaches and lifts metal particles to the tip of CNTs.

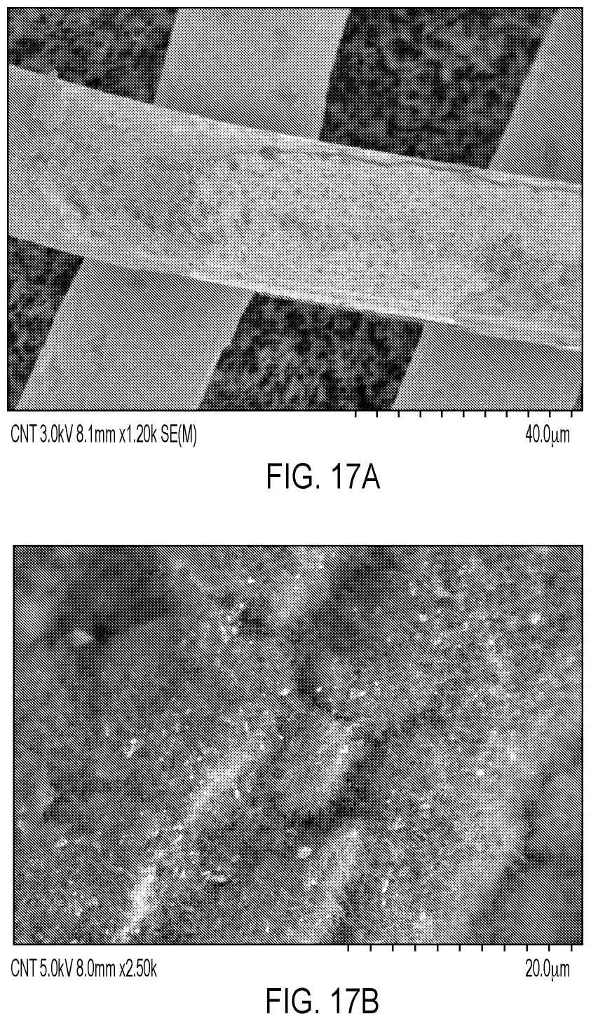

CNTs generated from reuse-6 contained 40% residue, mostly iron. It is likely that most of the difference from the initial run (i.e., 40%-10%=30%) can be attributed to extraneous metal particles, not to additional inclusions. Thus, the collected materials may contain loose microchips from iron, which were removed from the catalyst surface during sonication. This can explain this particular result of high residue and it also supports some of the high yields Y_{final} (up to 50%) which were shown in FIGS. 8A-C and 11A-C, which surprisingly rivaled the Yₚ yields (also up to 50%). FIG. 17A (upper left corner) illustrates such a little chip of catalyst on a reused screen and FIG. 17B shows some impurities, which may be particles of the catalyst. More aggressive purification should be able to remove such impurities. In fact, after removing iron by purification with 35% hydrochloric acid for 5 hrs, the metal residue in the sample dropped to only a few percent (FIG. 16).

### REFERENCES

Influence of Stainless-Steel Catalyst Substrate Type and Pretreatment on Growing Carbon Nanotubes from Waste Postconsumer Plastics” Aidin Panahi, Zixiang Wei, Guangchao Song, and Yiannis A. Levendis, Ind. Eng. Chem. Res. 2019, 58, 3009-3023.

DiLeo, R. A.; Landi, B. J.; Raffaelle, R. P. Purity assessment of multiwalled carbon nanotubes by Raman spectroscopy. 2007, 101 (6), 064307.

### INCORPORATION BY REFERENCE; EQUIVALENTS

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

What is claimed is:

1. A method of synthesizing a carbon nanostructure, the method comprising:
a) contacting a stainless steel substrate with an acid;
b) heating the stainless steel substrate to at least 600° C.;
c) quenching the stainless steel substrate;
d) in a non-oxidizing environment in a first furnace having a temperature from 600° C. to 1200° C., pyrolyzing an organic material in to obtain one or more gaseous decomposition products;
e) passing the one or more gaseous decomposition products across the stainless steel substrate in a second furnace having a temperature from 600° C. to 1200° C. to form the carbon nanostructure;
f) removing the carbon nanostructure from the stainless steel substrate; and
g) repeating steps a) through f) at least once.

2. The method of claim 1, wherein the stainless steel substrate is a wire mesh.

3. The method of claim 2, wherein the one or more gaseous decomposition products are passed across a plurality of wire meshes.

4. The method of claim 1, wherein the stainless steel substrate comprises stainless steel chips.

5. The method of claim 1, wherein the acid is hydrochloric acid.

6. The method of claim 1, wherein heating the stainless steel substrate is performed in air.

7. The method of claim 1, wherein the non-oxidizing environment comprises an inert gas.

8. The method of claim 7, wherein the inert gas is nitrogen.

9. The method of claim 1, wherein the non-oxidizing environment comprises water vapor.

10. The method of claim 1, further comprising mixing the one or more gaseous decomposition products with an oxidizing gas prior to passing the one or more gaseous decomposition products across the stainless steel substrate in the second furnace.

11. The method of claim 10, wherein the oxidizing gas comprises oxygen.

12. The method of claim 10, wherein the oxidizing gas is air.

13. The method of claim 1, wherein the organic material comprises polyethylene.

14. The method of claim 1, wherein the organic material comprises polystyrene.

15. The method of claim 1, wherein the organic material comprises polypropylene.

16. The method of claim 1, wherein the organic material comprises polyamide.

17. The method of claim 1, wherein steps a) through f) are performed a total of two through seven times.

18. The method of claim 1, wherein step b) is heating the stainless steel substrate to a temperature from 600° C. to 1200° C.

19. The method of claim 1, further comprising filtering the one or more gaseous decomposition products to remove any solid particles from the one or more gaseous decomposition products prior to passing the one or more gaseous decomposition products across the stainless steel substrate in the second furnace.
